(19) United States
(12) Patent Application Publication
(10) Pub. No.: US 2003/0083055 A1
(43) Pub. Date: May 1, 2003

(54) Local and remote access to radio parametric and regulatory data and methods therefor

(76) Inventors: Kenneth B. Riordan, Spring Grove, IL (US); Steve R. Bunch, Harvard, IL (US)

Correspondence Address: MOTOROLA INC, 600 NORTH US HIGHWAY 45, LIBERTYVILLE, IL, 60048-5343, US

(21) Appl. No.: 10/000,551

(22) Filed: Oct. 31, 2001

(51) Int. Cl. H04M 3/00

(52) U.S. Cl. 455/419; 455/552; 455/426; 455/186.1

(57) ABSTRACT

A radio device (10) having radio device information specific to the radio device, for example regulatory summary file (18) and specification information, stored thereon. In some embodiments, the radio device information may be displayed on the radio device. The radio device may also include a radio device information server address, for example a Universal Resource Locator (URL) link to an information server (30) for accessing the radio device information locally from the radio device or from a remote client (40).

### FIELD OF THE INVENTIONS

The present inventions relate generally to radio devices, and more particularly to radio devices having radio device information, for example regulatory certification information, specific to the radio device stored thereon for local and remote access and methods therefor.

### BACKGROUND OF THE INVENTIONS

Software defined radio (SDR) permits changing the performance of radio devices by reprogramming the device. Some elements of a programmable device configuration will have no bearing on radio performance, for example date book applications running on a JAVA virtual machine (VM). Other software defined radio configurations however will have a direct impact on radio performance, for example software implemented channel coder algorithms in cellular communication handsets.

In many countries, communication regulations require that a physical label bearing specified regulatory authorization and certification data be affixed to radio devices. In the United States, for example, the Federal Communications Commission (FCC) requires that an FCC identification number and other information label be displayed prominently on each device.

The various aspects, features and advantages of the present invention will become more fully apparent to those having ordinary skill in the art upon careful consideration of the following Detailed Description of the Invention with the accompanying drawings described below.

### BRIEF DESCRIPTION OF THE DRAWINGS

FIG. 1 is schematic view of a radio device having radio device summary information stored thereon and remote devices coupled thereto by a network for accessing the information.

FIG. 2 is a block diagram of an exemplary radio device.

### DETAILED DESCRIPTION OF THE INVENTIONS

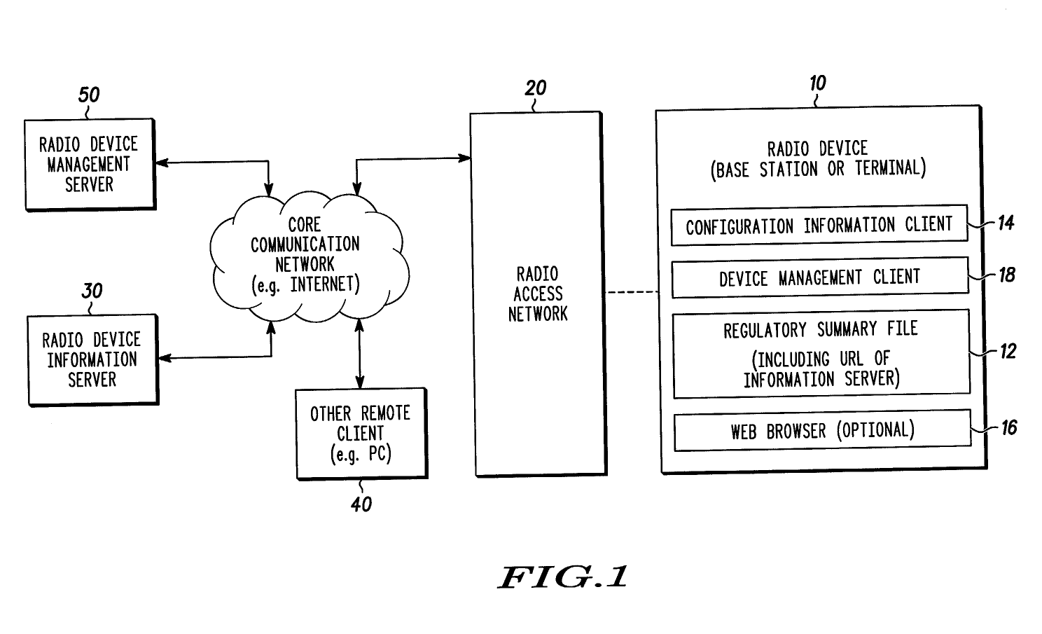

In FIG. 1, according to one aspect of the invention, a radio device 10 includes radio device information and/or a radio device information server address, for example a Universal Resource Locator (URL) link or some other server address, where information about the radio device may be obtained.

In one embodiment, the radio device information is specification information specific to the radio device, for example radio parametric data, test results, hardware and software version information, release dates and notes, operating and performance information, interface information, standards information, etc. The radio device information may also be regulatory information, for example Federal Communications Commission identification number and/or other regulatory information.

As noted above, some or all of the radio device information may be stored on a server accessible from the radio device or from some other remote location, as discussed more fully below. In embodiments where only a radio device information server address is stored on the radio device, a server identified by the radio device information server address provides all information for the radio device. In embodiments where both radio device information and a server address are stored on the radio device, the radio device information may be partial or summary information and the server identified by the server address may provide more complete radio device information.

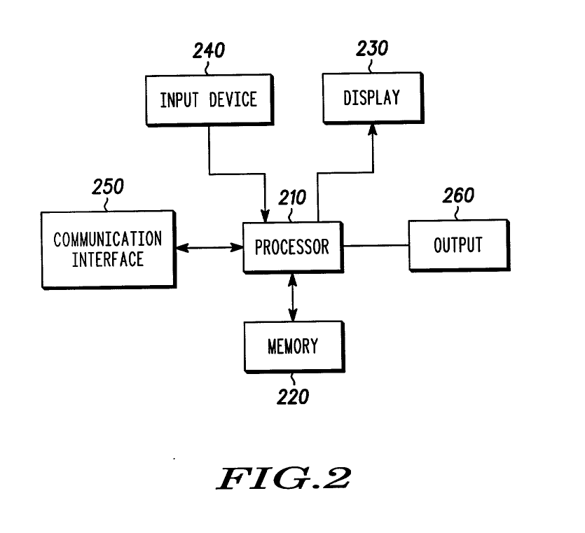

In FIG. 1, the radio device may be a fixed location device, for example a base station, or a terminal, for example a mobile communications handset. In embodiments where the radio device 10 is a terminal, the terminal may communicate with a radio access network 20. In FIG. 2, the radio device comprises generally a processor 210 coupled to memory 220 and other components specific to the device. The radio device information and/or the radio device information server address are stored in memory 220, for example in non-volatile memory, or read-only-memory (ROM), or non-reprogrammable flash memory.

In FIG. 1, the radio device information is a regulatory summary file 12 including a URL link for a radio device information server from which additional information about the radio device may be obtained. In other embodiments, the radio device information and the radio device information server address are stored as separate files on the radio device.

In FIG. 2, the exemplary radio device includes a display 230 coupled to the processor 210. In one application, the radio device information is regulatory information that may be displayed on the display, thus eliminating the need for a physical regulatory information label.

In one application, radio device information is displayed on the display in response to a local request, for example, in FIG. 2, a request made by a user at a user interface 240 of the radio device. In another embodiment, in response to a local request, radio device information is downloaded from the radio device, for example, in FIG. 2, from an output port 260 thereof. In other embodiments, the radio device information may be displayed upon applying power to the radio device and/or powering down radio device.

In software defined radio devices, there is generally a software programmable portion of the radio device coupled to the processor. In FIG. 2, for example, the communication interface 250 may be a software programmable portion having at least two software defined radio device configurations. Radio device information for each radio device configuration is stored in memory. The radio device information available depends upon the configuration of the software defined radio device. When the software defined radio device is reconfigured, the radio device information is reconfigured accordingly. In one embodiment, for example, when the software programmable portion is in a first radio device configuration, first radio device configuration regulatory information stored in the memory is accessible from the radio device, and when the software programmable portion is in a second radio device configuration, second radio device configuration regulatory information stored in the memory is accessible.

In another embodiment, in FIG. 1, the radio device 10 accesses some or all information about the radio device from a radio device information server 30 having radio device information. In the exemplary embodiment, a configuration information client 14 residing on the radio device 10 enables access to the radio device information server 30. The radio device information server 30 is identified by a radio device information server address stored on the radio device. In the exemplary embodiment of FIG. 1, the information server address is a Uniform Resource Locator link, which may be accessed by a Web browser 16 on the radio device 10, although the radio information server 30 may be accessed alternatively via networks other than the Internet. Radio device information may thus be accessed and/or downloaded from the radio information server 30 onto the radio device 10 for display and/or storage, and further downloading from an output port thereof.

In other applications, radio device information may be obtained from the radio device in response to a request from a remote location. In FIG. 1, for example, a remote client 40 communicates with the radio device 10 from a remote location, for example, via a network to retrieve radio device information either from the radio device 10 directly, or from the radio device information server 30 identified by an address obtained from the radio device 10. The remote client may obtain radio device information from the summary file 12 stored on the radio device 10, and/or more detailed radio device information may be accessed from the radio device information server 30 identified by the radio information server address stored on the radio device. Thus, for example, the remote client 40 may read and/or download, from the remote location, regulatory and other information stored on the radio device and/or on the information server 30.

In another embodiment, a radio management server 50 located remotely from the radio device communicates via a network with the radio device, and a device management client 18 stored on the radio device 10 enables the accessing radio device information and/or a radio device information server address identifying a serving having radio device information, or more detailed information than that stored on the radio device, as discussed above.

While the present inventions and what is considered presently to be the best modes thereof have been described in a manner that establishes possession thereof by the inventors and that enables those of ordinary skill in the art to make and use the inventions, it will be understood and appreciated that there are many equivalents to the exemplary embodiments disclosed herein and that myriad modifications and variations may be made thereto without departing from the scope and spirit of the inventions, which are to be limited not by the exemplary embodiments but by the appended claims.

What is claimed is:

1. A software defined radio device, comprising:
a processor;
memory coupled to the processor;
a software programmable portion coupled to the processor, the software programmable portion having a first radio device configuration and a second radio device configuration,
first radio device configuration regulatory information stored in the memory when the radio device is in the first radio device configuration,
second radio device configuration regulatory information stored in memory when the radio device is in the second radio device configuration.

2. The software defined radio device of claim 1, a radio device configuration information server address stored in the memory.

3. The software defined radio device of claim 2, the radio device configuration information server address is a Universal Resource Locator (URL) link.

4. The software defined radio device of claim 1, the first and second radio device configuration regulatory information includes first and second Federal Communications Commission (FCC) identification numbers corresponding to the first and second radio device configurations.

5. A radio device, comprising:
a processor;
memory coupled to the processor;
radio device regulatory information specific to the radio device stored in the memory of the radio device;
a display coupled to the processor, the display for displaying the radio device regulatory information;
a radio device information server Universal Resource Locator (URL) address stored in the memory.

6. The radio device of claim 5, the radio device regulatory information includes a Federal Communications Commission (FCC) identification number for the radio device.

7. A radio device, comprising:
a processor;
memory coupled to the processor;
radio device information specific to the radio device stored in the memory of the radio device;
a radio device information server address stored in the memory.

8. The radio device of claim 7, the radio device information includes radio device specification summary information.

9. The radio device of claim 7, a display coupled to the processor, the radio device information includes an FCC identification number, the display for displaying the radio device specification information.

10. A method for obtaining radio device information, comprising:
communicating with the radio device from the remote location;
accessing a radio device information server address stored on the radio device from the radio device to the remote location;
accessing radio device information specific to the radio device from which the radio device information server address was accessed by accessing a radio device information server identified by the radio device information server address.

11. The method of claim 10, the radio device information server address is a Universal Resource Locator (URL) link, accessing radio device information specific to the radio device from which the radio device information server address was retrieved by accessing a radio device information server identified by the URL.

12. The method of claim 10, the radio device comprises radio device information stored on the radio device, retrieving the radio device information from the radio device to the remote location.

13. The method of claim 10, the radio device comprises radio device regulatory information stored on the radio device, retrieving the radio device regulatory information from the radio device to the remote location.

14. The method of claim 13, displaying radio device regulatory information stored on the radio device on a display of the radio device.

15. The method of claim 10, the radio device comprises an FCC identification number stored on the radio device, retrieving the FCC identification number from the radio device to the remote location.

16. A method in a radio device, comprising:
accessing a radio device information server address stored on the radio device;
accessing a radio device information server from the radio device identified by the radio device information server addressed stored on the radio device;
accessing from the radio device radio device information specific to the radio device on the radio device information server identified by the radio device information server address.

17. The method of claim 16, accessing the radio device information server with a browser on the radio device.

18. The method of claim 16, accessing the radio device information server with a radio device information client on the radio device.
